(19) United States
(12) Patent Application Publication
(10) Pub. No.: US 2026/0275788 A1
(43) Pub. Date: Sep. 17, 2026

(54) VEHICLE DOOR DISPLACEMENT SYSTEM, VEHICLE, AND METHOD FOR OPERATING A VEHICLE DOOR DISPLACEMENT SYSTEM

(71) Applicants: Ningbo Geely Automobile Research & Development Co., Ltd., Ningbo (CN); Zhejiang Geely Holding Group Co., Ltd., Zhejiang (CN)

(72) Inventors: Kaj ANDERSSON, Mellerud (SE); Fredrik WALLANDER, Pixbo (SE)

(21) Appl. No.: 19/670,865

(22) Filed: May 7, 2026

Related U.S. Application Data
(63) Continuation of application No. PCT/CN2024/131322, filed on Nov. 11, 2024.

(30) Foreign Application Priority Data
Nov. 13, 2023 (EP) 23209474.8

(51) Int. Cl. E05D 15/28

(52) U.S. Cl. CPC E05D 15/28; E05Y 2201/47; E05Y 2201/686; E05Y 2900/531

(57) ABSTRACT

A vehicle door displacement system includes a displacement mechanism and an arm arranged between a vehicle body and a door. The arm is pivotably connected to the body and the door at inner and outer arm ends, respectively. The displacement mechanism includes first and second bars pivotably connected at a pivot point. The first bar is pivotably connected to the arm structure and the second bar is pivotably connected to the body. The displacement mechanism has a spring extending between the inner arm end and the first bar. The spring exerts an opening force onto the arm during opening and a closing force onto the arm during closing. During opening, the first and second bars pivot relative to each other around the pivot point in a first direction. During closing, the first and second bars pivot around the pivot point in a second direction opposite the first direction.

### RELATED APPLICATION DATA

This application is a continuation of International Patent Application No. PCT/CN2024/131322, filed Nov. 11, 2024, and claims the benefit of European Patent Application No. 23209474.8, filed Nov. 13, 2023, the disclosures of which are incorporated herein by reference in their entireties.

### TECHNICAL FIELD

The present disclosure relates to a vehicle door displacement system comprising a displacement mechanism and an arm structure. The arm structure is arranged between a vehicle body structure and a vehicle door. The arm structure is pivotably connected to the vehicle body structure at an inner arm end and pivotably connected to the vehicle door at an outer arm end. The arm structure is configured for displacing the vehicle door between a closed door position and open door positions. The disclosure further relates to a vehicle comprising a vehicle door displacement system and a method for operating a vehicle door displacement system.

### BACKGROUND

Vehicle door systems are used for covering an opening of a vehicle body structure, where the opening leads to an interior compartment of the vehicle. The door systems generally comprise a vehicle door displacement mechanism used for displacing a vehicle door relative to the opening between a closed door position and open door positions.

Traditionally, hinged vehicle doors are used, where the vehicle doors are connected to the vehicle body structure via hinges or similar arrangements, and displaced in relation to the vehicle body structure between open and closed positions by a swinging movement. Traditional hinged door systems are simple in construction but require a relatively large space outside the vehicle when being fully opened.

Sliding vehicle doors are becoming more popular and are instead mounted to or suspended in relation to the vehicle body structure via a track system, or a combined track and hinge system. The sliding vehicle doors are displaced in relation to the vehicle body structure between open and closed positions, by a sliding movement horizontally alongside the vehicle body structure. Sliding door systems and other alternative door systems have the advantage with smaller space needed for the opening and closing of the door compared to a hinged door solution. Current sliding door system solutions commonly use a mechanism in the sill area, which increases the height of the sill so that the step-over height for entering the interior compartment of the vehicle is higher than that of traditional hinged door systems. There is further a problem with sliding doors in that the sliding movement of the door is restricted by the mechanism.

Vehicle doors that are connected to the vehicle body structure with arms may be used as an alternative to sliding doors, where the arms are moved relative to the vehicle doors and the vehicle body structure upon displacement of the vehicle door between the closed and open door positions. When using movable arms, there may be issues with efficient opening and closing of the vehicle doors, with a need for adding opening or closing forces during door opening and door closing operations, due to door displacement kinematics and weak geometries. Such added forces may cause stress on electric motors used for opening or closing the vehicle doors, or cause inefficient handling of the vehicle doors if opened or closed manually. Sometimes gas springs are used for supporting a final door closing operation in the end of a door closing cycle. A problem with using a gas springs is that the force from the gas springs needs to be overcome when opening the vehicle doors.

There is thus a need for an improved vehicle door displacement system having movable arms, where the vehicle doors can be efficiently opened and closed with a robust and reliable door displacement functionality.

### SUMMARY

An object of the present disclosure is to provide a vehicle door displacement system, a vehicle comprising a vehicle door displacement system, and a method for operating a vehicle door displacement system, where the previously mentioned problems are avoided.

The disclosure concerns a vehicle door displacement system comprising a displacement mechanism and an arm structure. The arm structure is configured to be arranged between a vehicle body structure and a vehicle door. The arm structure is configured to be pivotably connected to the vehicle body structure at an inner arm end and the arm structure is configured to be pivotably connected to the vehicle door at an outer arm end. The arm structure is configured for displacing the vehicle door between a closed door position and an open door position. The displacement mechanism comprises a first bar and a second bar pivotably connected to each other via a bar pivot point. The first bar is pivotably connected to the arm structure and the second bar is configured to be pivotably connected to the vehicle body structure. The displacement mechanism further comprises a spring extending between the inner arm end and the first bar. The spring is configured for exerting an opening force onto the arm structure when the vehicle door is displaced from the closed door position to the open door position and a closing force onto the arm structure when the vehicle door is displaced from the open door position to the closed door position. During displacement from the closed door position to the open door position, the first bar and the second bar are pivoted relative to each other around the bar pivot point in a first bending direction. During displacement from the open door position to the closed door position, the first bar and the second bar are pivoted relative to each other around the bar pivot point in a second bending direction opposite the first bending direction.

Advantages with these features are that the vehicle door displacement system is supporting efficient opening and closing of the vehicle door, by applying the opening and closing forces during door opening and door closing operations. The forces are in this way supporting the opening and closing operations even for weak geometries, and may relieve stress on electric motors used for opening or closing the vehicle door. The first bar and the second bar are through the pivoting displacements in the first bending direction and second bending direction respectively providing an efficient door operation, where the spring is exerting the opening force onto the arm structure when the vehicle door is displaced from the closed door position to the open door position and exerting the closing force onto the arm structure when the vehicle door is displaced from the open door position to the closed door position. The vehicle door displacement system is enabling efficient door opening and closing operations with a robust and reliable door displacement functionality.

In one embodiment, during an initial opening displacement from the closed door position to the open door position, a first inner side of the first bar and a second inner side of the second bar are pivoted towards each other around the bar pivot point in the first bending direction. During a final opening displacement, the first inner side and the second inner side are pivoted away from each other around the bar pivot point in the first bending direction. The first bending direction is defined as positions of the first bar and the second bar relative to each other, where the first inner side and the second inner side are arranged towards each other. In the first bending direction, the first bar and the second bar are pivoted such that the first inner side and the second inner side are facing each other.

In one embodiment, during an initial closing displacement from the open door position to the closed door position, a first outer side of the first bar and a second outer side of the second bar are pivoted towards each other around the bar pivot point in the second bending direction. During a final closing displacement, the first outer side and the second outer side are pivoted away from each other around the bar pivot point in the second bending direction. The second bending direction is defined as positions of the first bar and the second bar relative to each other, where instead the first outer side and the second outer side are arranged towards each other. In the second bending direction, the first bar and the second bar are pivoted such that the first outer side and the second outer side are facing each other.

In one embodiment, the arm structure is pivotably connected to the vehicle body structure at the inner arm end via an inner arm pivot point. The inner arm pivot point is used for an efficient displacement of the arm structure.

In one embodiment, a first outer end of the first bar is pivotably connected to the inner arm end of the arm structure via an outer bar pivot point. A first inner end of the first bar is pivotably connected to the second bar via the bar pivot point. A second outer end of the second bar is pivotably connected to the first bar via the bar pivot point. A second inner end of the second bar is pivotably connected to the vehicle body structure via an inner bar pivot point. The respective pivot points are connecting the first bar and the second bar to each other, the first bar to the arm structure, and the second bar to the vehicle body structure, for an efficient operation of the displacement mechanism.

In one embodiment, the inner arm end of the arm structure comprises a first extending portion. The first extending portion is configured for extending in an inwards direction from the inner arm end towards an inner side of the vehicle when the vehicle door is arranged in the closed door position. The outer bar pivot point is arranged on the first extending portion spaced apart from the inner arm pivot point. The first extending portion is providing a suitable geometry for the vehicle door displacement system.

In one embodiment, the inner arm end of the arm structure comprises a second extending portion. The second extending portion is configured for extending in an outwards direction from the inner arm end towards an outer side of the vehicle when the vehicle door is arranged in the closed door position. The spring is attached to the second extending portion. The second extending portion is providing an efficient positioning of the spring relative to the first bar during the door opening and closing operations.

In one embodiment, the first extending portion and the second extending portion are arranged on a common bracket structure attached to and forming part of the arm structure. The common bracket structure is simplifying the construction of the vehicle door displacement system.

In one embodiment, the arm structure is configured to pivot relative to the vehicle body structure and the vehicle door when displacing the vehicle door between the closed door position and the open door position. Upon pivoting movement of the arm structure relative to the vehicle body structure, the first bar is configured for pivoting relative to the arm structure and the second bar, and the second bar is configured for pivoting relative to the vehicle body structure and the first bar. The pivoting movements are supporting the exerting of the opening and closing forces.

In one embodiment, the spring is arranged as a coil spring configured for exerting an opening force onto the arm structure when the vehicle door is displaced from the closed door position to the open door position, and exerting a closing force onto the arm structure when the vehicle door is displaced from the open door position to the closed door position. The coil spring is providing a simple and reliable spring configuration.

The disclosure further concerns a vehicle comprising a vehicle door displacement system as described above.

The disclosure further concerns a method for operating a vehicle door displacement system comprising a displacement mechanism and an arm structure. The arm structure is arranged between a vehicle body structure and a vehicle door. The arm structure is pivotably connected to the vehicle body structure at an inner arm end and pivotably connected to the vehicle door at an outer arm end. The arm structure is configured for displacing the vehicle door between a closed door position and an open door position. The displacement mechanism comprises a first bar and a second bar pivotably connected to each other via a bar pivot point. The first bar is pivotably connected to the arm structure and the second bar is pivotably connected to the vehicle body structure. The displacement mechanism further comprises a spring extending between the inner arm end and the first bar. The method comprises the steps: pivoting the first bar and the second bar relative to each other around the bar pivot point in a first bending direction during displacement of the vehicle door from the closed door position to the open door, and exerting an opening force onto the arm structure by the spring when the vehicle door is displaced from the closed door position to the open door position; pivoting the first bar and the second bar relative to each other around the bar pivot point in a second bending direction opposite the first bending direction during displacement of the vehicle door from the open door position to the closed door position, and exerting a closing force onto the arm structure by the spring when the vehicle door is displaced from the open door position to the closed door position.

Advantages with these features are that the method for operating the vehicle door displacement system is supporting efficient opening and closing of the vehicle door, by applying the opening and closing forces during door opening and door closing operations. The forces are in this way efficiently supporting the opening and closing operations even for weak geometries, and may relieve stress on electric motors used for opening or closing the vehicle door. The first bar and the second bar are through the pivoting displacements in the first bending direction and second bending direction respectively providing an efficient door operation, where the spring is exerting the opening force onto the arm structure when the vehicle door is displaced from the closed door position to the open door position and exerting the closing force onto the arm structure when the vehicle door is displaced from the open door position to the closed door position. The method is enabling efficient door opening and closing operations with a robust and reliable door displacement functionality.

In one embodiment, the method further comprises the steps: pivoting a first inner side of the first bar and a second inner side of the second bar towards each other around the bar pivot point in the first bending direction during an initial opening displacement from the closed door position to the open door position; and pivoting the first inner side and the second inner side away from each other around the bar pivot point in the first bending direction during a final opening displacement. The first bending direction is defined as positions of the first bar and the second bar relative to each other, where the first inner side and the second inner side are arranged towards each other. In the first bending direction, the first bar and the second bar are pivoted such that the first inner side and the second inner side are facing each other.

In one embodiment, the method further comprises the steps: pivoting a first outer side of the first bar and a second outer side of the second bar towards each other around the bar pivot point in the second bending direction during an initial closing displacement from the open door position to the closed door position; and pivoting the first outer side and the second outer side away from each other around the bar pivot point in the second bending direction during a final closing displacement. The second bending direction is defined as positions of the first bar and the second bar relative to each other, where instead the first outer side and the second outer side are arranged towards each other. In the second bending direction, the first bar and the second bar are pivoted such that the first outer side and the second outer side are facing each other.

In one embodiment, the spring is exerting the opening force onto the arm structure during the initial opening displacement and/or the final opening displacement, and/or the spring is exerting the closing force onto the arm structure during the initial closing displacement and/or the final closing displacement. In this way, the spring is efficiently applying the opening and closing forces.

### BRIEF DESCRIPTION OF THE DRAWINGS

The disclosure will be described in detail in the following, with reference to the attached drawings, in which

FIGS. 1A-1B show schematically, in side views, a vehicle having a vehicle door displacement system with a vehicle door arranged in a closed door position and in an open door position,

FIG. 2 shows schematically, in an inner side view, the vehicle door displacement system with the vehicle door arranged in the closed door position,

FIGS. 3A-3I show schematically, in perspective views from above, the vehicle door displacement system in different operating positions, and

FIG. 4 shows schematically, in a perspective view from above, a section of the vehicle door displacement system.

### DETAILED DESCRIPTION OF EXAMPLE EMBODIMENTS

Various aspects of the disclosure will hereinafter be described in conjunction with the appended drawings to illustrate and not to limit the disclosure, wherein like designations denote like elements, and variations of the described aspects are not restricted to the specifically shown embodiments, but are applicable on other variations of the disclosure.

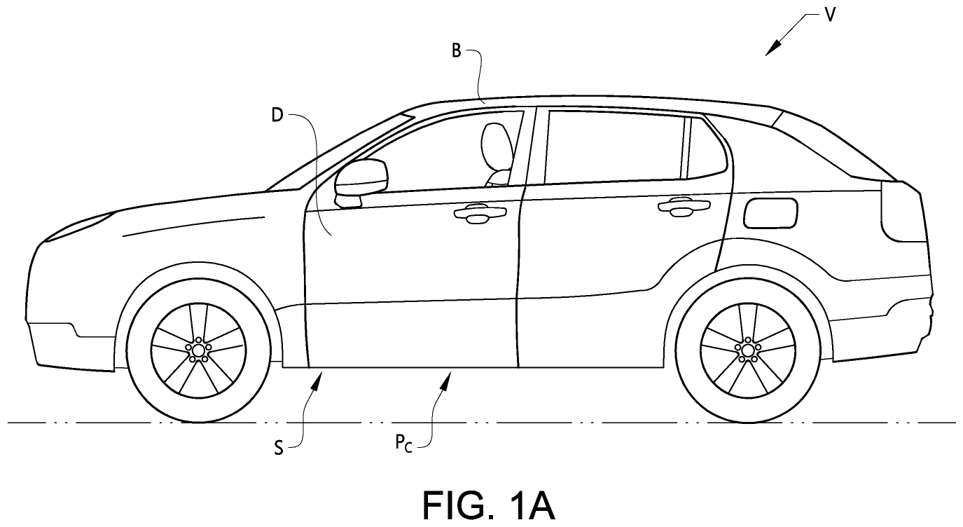

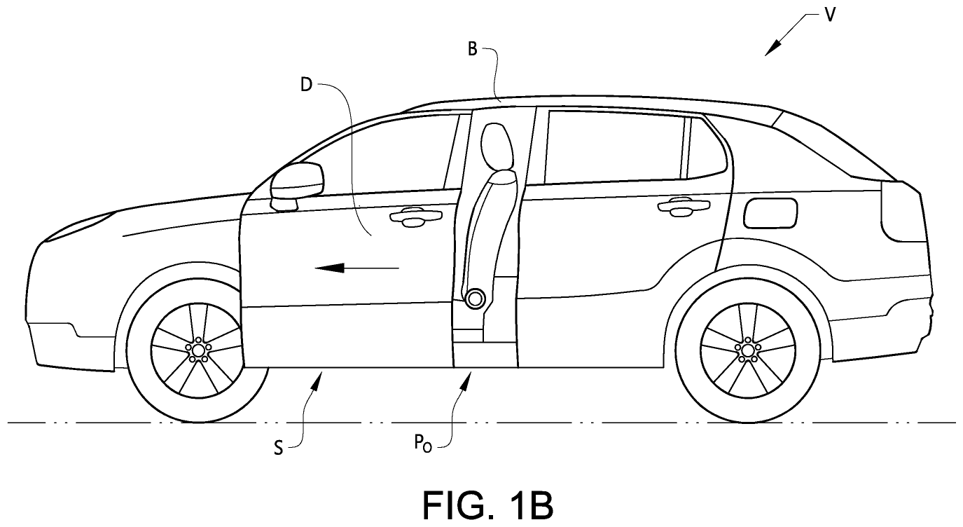

FIGS. 1A-1B schematically show a vehicle V comprising a vehicle door displacement system S. The vehicle V comprises vehicle doors D movably arranged relative to a vehicle body structure B of the vehicle V. The vehicle door displacement system S will be described in connection to a vehicle door D arranged as a front side door of the vehicle V, as illustrated in the figures. It should however be understood that the configuration of the vehicle door D may be applicable on other door structures of the vehicle V, such as a vehicle door D arranged as a rear side door.

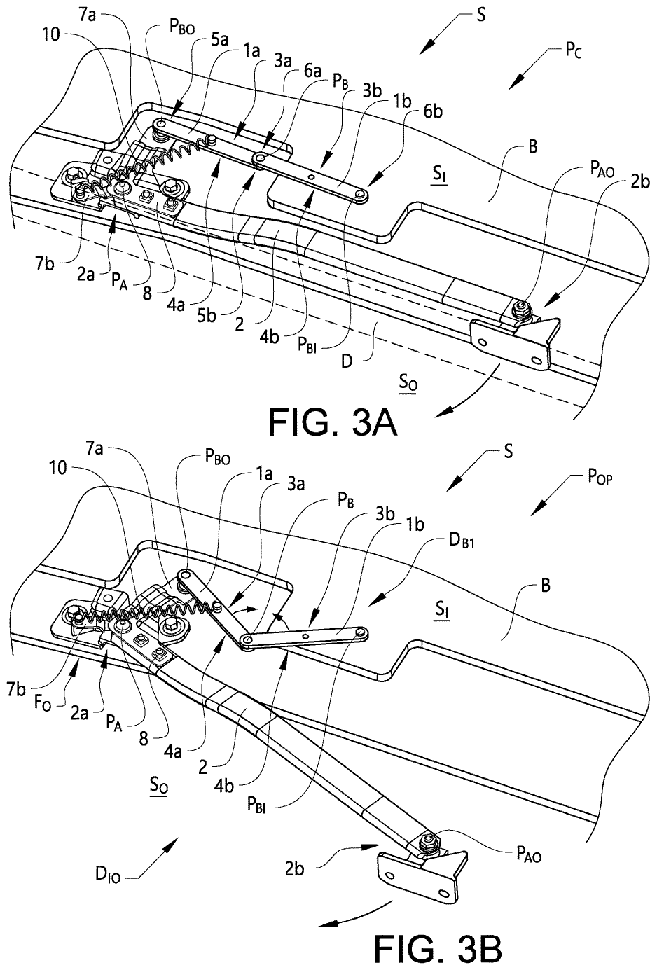

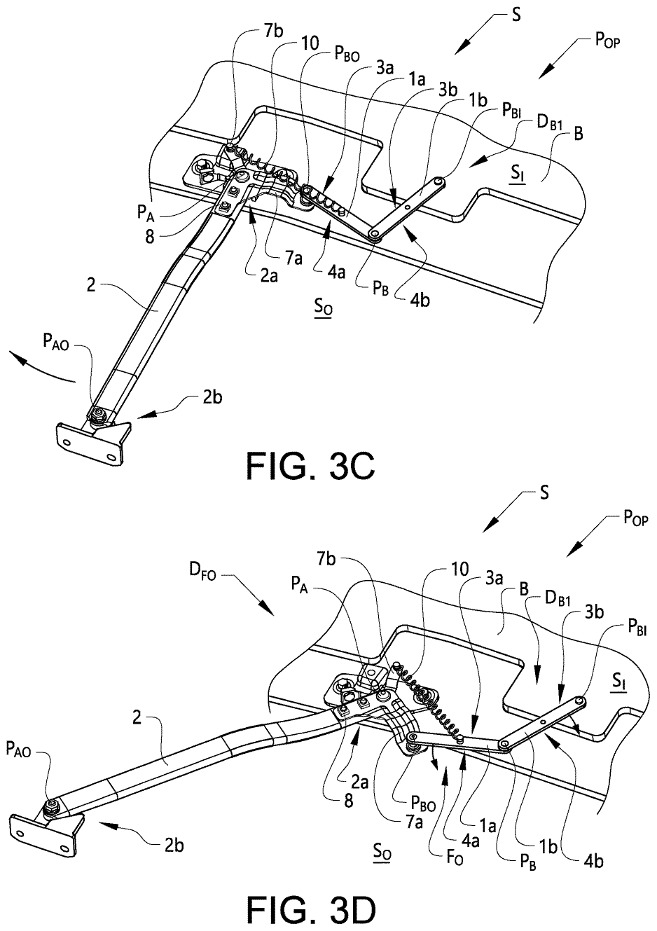

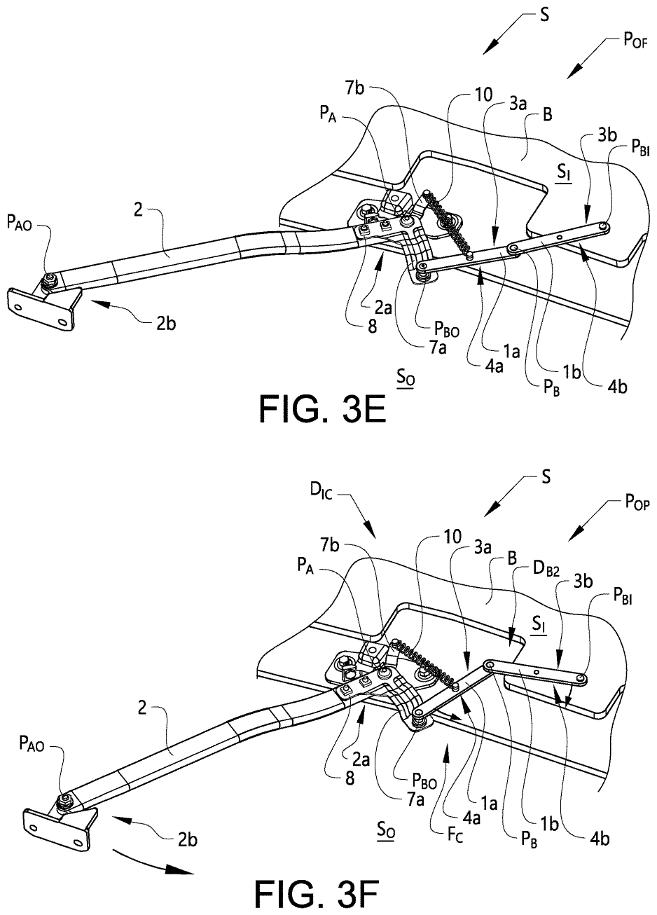

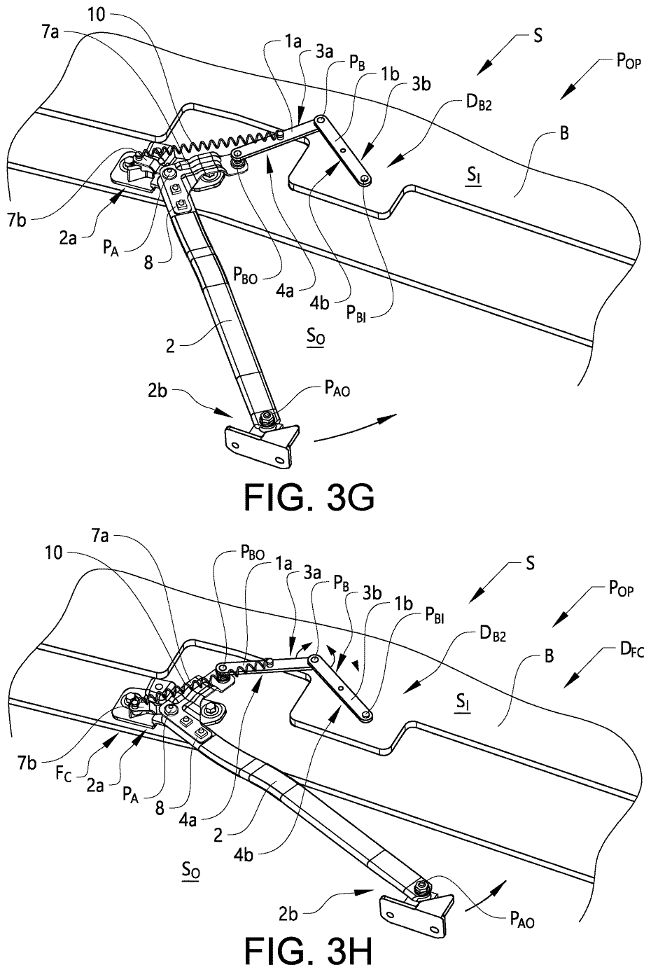

In FIG. 1A, the vehicle door D is arranged in a closed door position P_{C}, and in FIG. 1B, the vehicle door D is arranged in an open door position P_{O}. The vehicle door D is movably arranged relative to the vehicle body structure B between the closed door position P_{C} and open door positions P_{O}. Any position in which the vehicle door D has been displaced away from the closed door position P_{C} may be considered an open door position P_{O}, such as a partly open door position or a fully open door position. A closed door position P_{C} of the vehicle door D is schematically shown in FIGS. 3A and 3I, partly open door positions P_{OP} of the vehicle door D during a door opening operation are schematically shown in FIGS. 3B-3D, a fully open door position P_{OF} of the vehicle door D is schematically shown in FIG. 3E, and partly open door positions P_{OP} of the vehicle door D during a door closing operation are schematically shown in FIGS. 3F-3H. The vehicle door D is shown with dotted lines in FIG. 3A, but not shown in FIGS. 3B-3I for illustrative purposes.

The vehicle door displacement system S comprises a displacement mechanism 1 and an arm structure 2. The arm structure 2 is arranged between the vehicle body structure B and the vehicle door D.

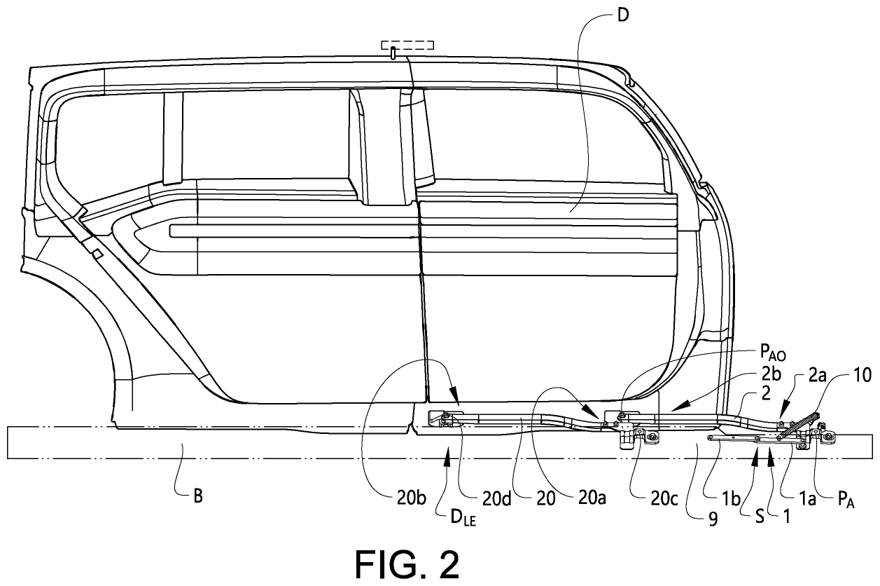

The vehicle door D is connected to the vehicle body structure B via the arm structure 2, as shown in for example FIG. 2. In the shown embodiment, the vehicle door D is further connected to the vehicle body structure B via a supporting arm structure 20 for efficient displacement of the vehicle door D between the closed door position P_{C} and the fully open door position P_{OF}. The arm structure 2 and the supporting arm structure 20 are arranged at a lower end D_{LE} of the vehicle door D. The arm structure 2 and the supporting arm structure 20 are moved relative to the vehicle door D and the vehicle body structure B upon displacement of the vehicle door D between the closed door position P_{C} and the open door positions P_{O}. In this way, the arm structure 2 and the supporting arm structure 20 are providing a simple and reliable opening and closing of the vehicle door D. In the shown embodiment, the vehicle door D is arranged as a front side door in direct connection to a rear side door and the vehicle V may be arranged with a large door opening having no supporting B-pillar.

In the illustrated embodiment, where the vehicle door D is arranged as a front side door, arm structure 2 is arranged forwards of the supporting arm structure 20. In other non-illustrated embodiments, the arm structure 2 may instead be arranged rearwards of the supporting arm structure 20.

The arm structure 2 comprises an inner arm end 2a and an outer arm end 2b. The arm structure 2 is pivotably connected to the vehicle body structure B at the inner arm end 2a and pivotably connected to the vehicle door D at the outer arm end 2b, as shown in FIG. 2. The arm structure 2 is in this way pivotably arranged relative to both the vehicle door D and the vehicle body structure B, and configured for displacing the vehicle door D between the closed door position P_{C} and an open door positions P_{O}. The arm structure 2 is pivotably connected to the vehicle body structure B at the inner arm end 2a via an inner arm pivot point P_{A}, and the arm structure 2 is pivotably connected to the vehicle door D at the outer arm end 2b via an outer arm pivot point P_{AO}. Suitably, the inner arm end 2a is pivotably connected to a side sill structure 9 forming part of the vehicle body structure B. The arm structure 2 is configured for pivoting around the inner arm pivot point P_{A} and the outer arm pivot point P_{AO} upon displacement of the vehicle door D between the closed door position P_{C} and the open door positions P_{O}. The inner arm pivot point P_{A} and the outer arm pivot point P_{AO} are suitably arranged as shafts or axle structures around which the arm structure 2 is allowed to pivot upon displacement of the vehicle door D relative to the vehicle body structure B. The shafts or axle structures are suitably arranged in a holding structure or similar arrangement attached to the vehicle body structure B and the vehicle door D respectively.

The supporting arm structure 20 comprises a second inner arm end 20a pivotably connected to the vehicle body structure B and a second outer arm end 20b pivotably connected to the vehicle door D, as shown in FIG. 2. The supporting arm structure 20 is in this way pivotably arranged relative to both the vehicle door D and the vehicle body structure B. The second inner arm end 20a is pivotably connected to the vehicle body structure B via a second inner arm pivot point 20c and the second outer arm end 20b is pivotably connected to the vehicle door D via a second outer arm pivot point 20d. Suitably, the second inner arm end 20a is pivotably connected to a side sill structure 9 forming part of the vehicle body structure B. The supporting arm structure 20 is configured for pivoting around the second inner arm pivot point 20c and the second outer arm pivot point 20d upon displacement of the vehicle door D between the closed door position P_{C} and the open door positions P_{O}. The second inner arm pivot point 20c and the second outer arm pivot point 20d are suitably arranged as shafts or axle structures around which the supporting arm structure 20 is allowed to pivot upon displacement of the vehicle door D relative to the vehicle body structure B. The shafts or axle structures are suitably arranged in a holding structure or similar arrangement attached to the vehicle body structure B and the vehicle door D respectively.

The displacement mechanism 1 is supporting the door opening and door closing operations by applying an opening force F_{O} and a closing force F_{C} respectively onto the arm structure 2. The displacement mechanism 1 comprises a first bar 1a and a second bar 1b pivotably connected to each other via a bar pivot point P_{B}, as shown in FIGS. 3A-3I. The first bar 1a is pivotably connected to the arm structure 2 and the second bar 1b is pivotably connected to the vehicle body structure B. The displacement mechanism 1 further comprises a spring 10 extending between the inner arm end 2a of the arm structure 2 and the first bar 1a. The spring 10 is exerting the opening force F_{O} onto the arm structure 2 when the vehicle door D is displaced from the closed door position P_{C} to the open door position P_{O}. The spring 10 is exerting the closing force F_{C} onto the arm structure 2 when the vehicle door D is displaced from the open door position P_{O} to the closed door position P_{C}.

The first bar 1a comprises a first inner side 3a and a first outer side 4a. As shown in FIG. 3a, the first inner side 3a is arranged towards an inner side S_{I} of the vehicle V when the vehicle door D is arranged in the closed door position P_{C}, and the first outer side 4a is arranged towards an outer side S_{O} of the vehicle V when the vehicle door D is arranged in the closed door position P_{C}.

The second bar 1b comprises a second inner side 3b and a second outer side 4b. As shown in FIG. 3A, the second inner side 3b is arranged towards the inner side S_{I} of the vehicle V when the vehicle door D is arranged in the closed door position P_{C}, and the second outer side 4b is arranged towards an outer side S_{O} of the vehicle V when the vehicle door D is arranged in the closed door position P_{C}.

The first inner side 3a the second inner side 3b are typically arranged towards an interior structure of the vehicle V in the closed door position P_{C}, such as an interior compartment of the vehicle. In this way, the first inner side 3a and the second inner side 3b are facing the inner side S_{I} of the vehicle V formed by the interior structure in the closed door position P_{C}. The first outer side 4a and the second outer side 4b are arranged towards the exterior outside the vehicle V in the closed door position P_{C}. In this way, the first outer side 4a and the second outer side 4b are facing the outer side S_{O} of the vehicle V, such as an outer side of the vehicle door D, as understood from FIG. 3A.

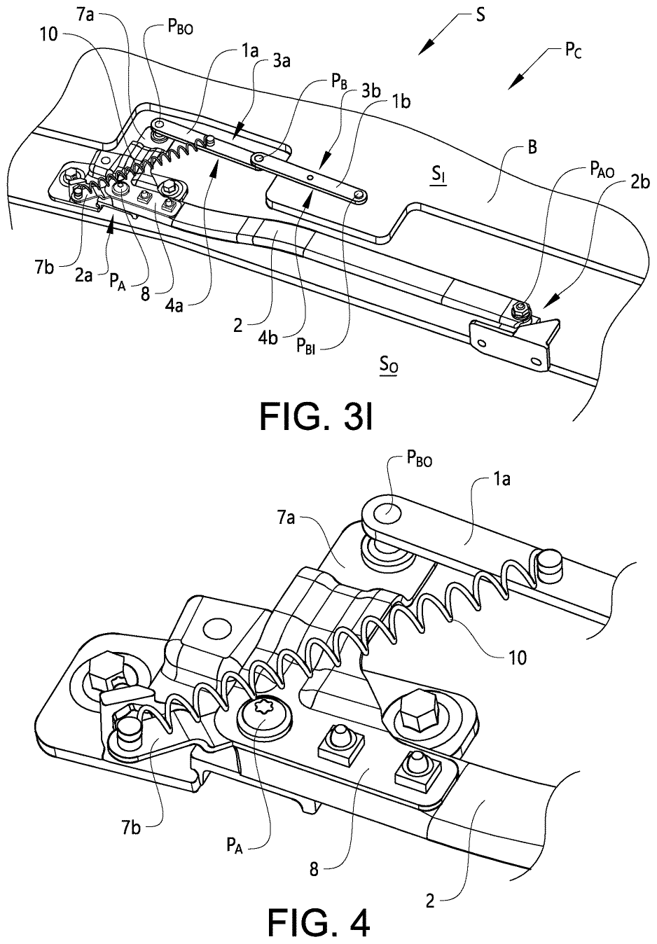

A first outer end 5a of the first bar 1a is pivotably connected to the inner arm end 2a of the arm structure 2 via an outer bar pivot point P_{BO}, as shown in FIGS. 3A and 4. A first inner end 6a of the first bar 1a is pivotably connected to the second bar 1b via the bar pivot point P_{B}. A second outer end 5b of the second bar 1b is pivotably connected to the first bar 1a via the bar pivot point P_{B}. A second inner end 6b of the second bar 1b is pivotably connected to the vehicle body structure B via an inner bar pivot point P_{BI}. The spring 10 is connected to the first bar 1a at a suitable position between the bar pivot point P_{B} and the outer bar pivot point P_{BO}.

The inner arm end 2a of the arm structure 2 comprises a first extending portion 7a, and the first extending portion 7a is extending in an inwards direction from the inner arm end 2a towards an inner side S_{I} of the vehicle when the vehicle door D is arranged in the closed door position P_{C}, as understood from FIG. 3A. The outer bar pivot point P_{BO} is arranged on the first extending portion 7a spaced apart from the inner arm pivot point P_{A}.

The inner arm end 2a of the arm structure 2 comprises a second extending portion 7b, and the second extending portion 7b is extending in an outwards direction from the inner arm end 2a towards the outer side S_{O} of the vehicle when the vehicle door D is arranged in the closed door position P_{C}, as understood from FIG. 3A. The spring 10 is attached to the second extending portion 7b, as shown in for example FIG. 4.

The first extending portion 7a and the second extending portion 7b are arranged on a common bracket structure 8 attached to and forming part of the arm structure 2.

The arm structure 2 is pivoting relative to the vehicle body structure B and the vehicle door D when displacing the vehicle door D between the closed door position P_{C} and the open door position P_{O}. Upon pivoting movement of the arm structure 2 relative to the vehicle body structure B, the first bar 1a is pivoting relative to the arm structure 2 and the second bar 1b, and the second bar 1b is pivoting relative to the vehicle body structure B and the first bar 1a.

The spring 10 is in the shown embodiment arranged as a coil spring. The spring 10 is exerting an opening force F_{O} onto the arm structure 2 when the vehicle door D is displaced from the closed door position P_{C} to the open door position P_{O}. The spring 10 is exerting a closing force F_{C} onto the arm structure 2 when the vehicle door D is displaced from the open door position P_{O} to the closed door position P_{C}. It should however be understood that the spring 10 may have any other suitable configuration, such as other types of extension springs, or gas springs having similar characteristics.

During a door opening sequence, where the vehicle door D is displaced from the closed door position P_{C} to the open door position P_{O}, the first bar 1a and the second bar 1b are pivoted relative to each other around the bar pivot point P_{B} in a first bending direction D_{B1}, as will be described below in connection to FIGS. 3A-3E.

During a door closing sequence, where the vehicle door D is displaced from the open door position P_{O} to the closed door position P_{C}, the first bar 1a and the second bar 1b are pivoted relative to each other around the bar pivot point P_{B} in a second bending direction D_{B2} opposite the first bending direction D_{B1}, as will be described below in connection to FIGS. 3E-3I.

The first bending direction D_{B1} is defined as positions of the first bar 1a and the second bar 1b relative to each other, where the first inner side 3a and the second inner side 3b are arranged towards each other, as illustrated in FIGS. 3B-3D. In the first bending direction D_{B1}, the first bar 1a and the second bar 1b are pivoted such that the first inner side 3a and the second inner side 3b are facing each other, and such that that the first outer side 4a and the second outer side 4b are facing away from each other.

The second bending direction D_{B2} is defined as positions of the first bar 1a and the second bar 1b relative to each other, where instead the first outer side 4a and the second outer side 4b are arranged towards each other, as illustrated in FIGS. 3F-3H. In the second bending direction D_{B2}, the first bar 1a and the second bar 1b are pivoted such that the first outer side 4a and the second outer side 4b are facing each other, and such that that the first inner side 3a and the second inner side 3b are facing away from each other.

A door opening operation from the closed door position P_{C} to the fully open door position P_{OF} is sequentially illustrated in FIGS. 3A-3E. In FIG. 3A, the vehicle door D is arranged in the closed door position P_{C}, and in FIG. 3E, the vehicle door is arranged in the fully open door position P_{OF}. When the vehicle door D is opened from the closed door position P_{C}, a door opening sequence is initiated.

During an initial opening displacement D_{IO} from the closed door position P_{C} towards the fully open door position P_{OF}, the first inner side 3a of the first bar 1a and the second inner side 3b of the second bar 1b are pivoted towards each other around the bar pivot point P_{B} in the first bending direction D_{B1} through action from the spring 10, as illustrated with the arrows in FIG. 3B. Upon continued opening displacement of, the vehicle door D towards the fully open door position P_{OF}, the first inner side 3a and the second inner side 3b are further pivoted towards each other around the bar pivot point P_{B} in the first bending direction D_{B1}, as shown in FIG. 3C. During a final opening displacement D_{FO} towards the fully open door position P_{OF}, the first inner side 3a and the second inner side 3b are pivoted away from each other around the bar pivot point P_{B} in the first bending direction D_{B1}, as shown with the arrows in FIG. 3D, and further pivoted away from each other to the fully open door position P_{OF} shown in FIG. 3E. Thus, during the door opening sequence, the first inner side 3a and the second inner side 3b are first pivoted towards each other around the bar pivot point P_{B} in the first bending direction D_{B1}, and thereafter the first inner side 3a and the second inner side 3b are pivoted away from each other around the bar pivot point P_{B} in the first bending direction D_{B1}. The specific angular position between the first bar 1a and the second bar 1b where the pivoting movement shift from pivoting towards each other to pivoting away from each other may depend on the specific geometry of the displacement mechanism 1 and the arm structure 2.

A door closing operation from the fully open door position P_{OF} to the closed door position P_{C} is sequentially illustrated in FIGS. 3E-3I. In FIG. 3E, the vehicle door D is arranged in the fully open door position P_{OF}, and in FIG. 3I, the vehicle door is arranged in the closed door position P_{C}. When the vehicle door D is closed from the fully open door position P_{OF}, a door closing sequence is initiated.

During an initial closing displacement D_{IC} from the fully open door position P_{OF} to the closed door position P_{C}, the first outer side 4a of the first bar 1a and the second outer side 4b of the second bar 1b are pivoted towards each other around the bar pivot point P_{B} in the second bending direction D_{B2} through action from the spring 10, as illustrated with the arrows in FIG. 3F. Upon continued closing displacement of the vehicle door D towards the closed door position P_{C}, the first outer side 4a and the second outer side 4b are further pivoted towards each other around the bar pivot point P_{B} in the second bending direction D_{B2}, as shown in FIG. 3G. During a final closing displacement D_{FC} towards the closed door position P_{C}, the first outer side 4a and the second outer side 4b are pivoted away from each other around the bar pivot point P_{B} in the second bending direction D_{B2}, as shown with the arrows in FIG. 3H, and further pivoted away from each other to the closed door position P_{C} shown in FIG. 3I. Thus, during the door closing sequence, the first outer side 4a and the second outer side 4b are first pivoted towards each other around the bar pivot point P_{B} in the second bending direction D_{B2}, and thereafter the first outer side 4a and the second outer side 4b are pivoted away from each other around the bar pivot point P_{B} in the second bending direction D_{B2}. The specific angular position between the first bar 1a and the second bar 1b where the pivoting movement shift from pivoting towards each other to pivoting away from each other may depend on the specific geometry of the displacement mechanism 1 and the arm structure 2.

The vehicle door displacement system S is enabling efficient opening operations of the vehicle door D, by pivoting the first bar 1a and the second bar 1b relative to each other around the bar pivot point P_{B} in the first bending direction D_{B1} during displacement of the vehicle door D from the closed door position P_{C} to the open door position P_{O}, and exerting the opening force F_{O} onto the arm structure 2 by the spring 10 when the vehicle door D is displaced from the closed door position P_{C} to the open door position P_{O}. The first inner side 3a of the first bar 1a and the second inner side 3b of the second bar 1b are pivoted towards each other around the bar pivot point P_{B} in the first bending direction D_{B1} during the initial opening displacement D_{IO} from the closed door position P_{C} to the open door position P_{O}, and the first inner side 3a and the second inner side 3b are pivoted away from each other around the bar pivot point P_{B} in the first bending direction D_{B1} during the final opening displacement D_{FO}. The spring 10 is exerting the opening force F_{O} onto the arm structure 2 during the initial opening displacement D_{IO} and/or the final opening displacement D_{IF}.

The vehicle door displacement system S is further enabling efficient closing operations of the vehicle door D, by pivoting the first bar 1a and the second bar 1b relative to each other around the bar pivot point P_{B} in the second bending direction D_{B2} during displacement of the vehicle door D from the open door position P_{O} to the closed door position P_{C}, and exerting the closing force F_{C} onto the arm structure 2 by the spring 10 when the vehicle door D is displaced from the open door position P_{O} to the closed door position P_{C}. The first outer side 4a of the first bar 1a and the second outer side 4b of the second bar 1b are pivoted towards each other around the bar pivot point P_{B} in the second bending direction D_{B2} during the initial closing displacement D_{IC} from the open door position P_{O} to the closed door position P_{C}, and the first outer side 4a and the second outer side 4b are pivoted away from each other around the bar pivot point P_{B} in the second bending direction D_{B1} during the final closing displacement D_{FC}. The spring 10 is exerting the closing force F_{C} onto the arm structure 2 during the initial closing displacement D_{IC} and/or the final closing displacement D_{FC}.

The displacement mechanism 1 with the first bar 1a and the second bar 1b described above is extending between the arm structure 2 and the vehicle body structure B, but the displacement mechanism 1 could also be mounted to extend between the arm structure 2 and the vehicle door D.

It will be appreciated that the above description is merely exemplary in nature and is not intended to limit the present disclosure, its application or uses. While specific examples have been described in the specification and illustrated in the drawings, it will be understood by those of ordinary skill in the art that various changes may be made and equivalents may be substituted for elements thereof without departing from the scope of the present disclosure. Furthermore, modifications may be made to adapt a particular situation or material to the teachings of the present disclosure without departing from the essential scope thereof. Therefore, it is intended that the present disclosure not be limited to the particular examples illustrated by the drawings and described in the specification as the best mode presently contemplated for carrying out the teachings of the present disclosure, but that the scope of the present disclosure will include any embodiments falling within the foregoing description. Reference signs mentioned in the claims should not be seen as limiting the extent of the matter protected by the claims, and their sole function is to make claims easier to understand.

### Reference Signs

1: Displacement mechanism
1a: First bar
1b: Second bar
2: Arm structure
2a: Inner arm end
2b: Outer arm end
3a: First inner side, First bar
3b: Second inner side, Second bar
4a: First outer side, First bar
4a: Second outer side, Second bar
5a: First outer end, First bar
5b: Second outer end, Second bar
6a: First inner end, First bar
6b: Second inner end, Second bar
7a: First extending portion
7b: Second extending portion
8: Bracket structure
9: Side sill structure
10: Spring
20: Supporting arm structure
20a: Second inner arm end
20b: Second outer arm end
20c: Second inner arm pivot point
20d: Second outer arm pivot point
B: Vehicle body structure
D: Vehicle door
D_{B1}: First bending direction
D_{B2}: Second bending direction
D_{IC}: Initial closing displacement
D_{IO}: Initial opening displacement
D_{FC}: Final closing displacement
D_{FO}: Final opening displacement
D_{LE}: Lower end, Vehicle door
P_{A}: Inner arm pivot point
P_{AO}: Outer arm pivot point
P_{B}: Bar pivot point
P_{BI}: Inner bar pivot point
P_{BO}: Outer bar pivot point
P_{C}: Closed door position
P_{O}: Open door position
P_{OF}: Fully open door position
P_{OP}: Partly open door positions
S: Vehicle door displacement system
S_{I}: Inner side
S_{O}: Outer side

What is claimed is:

1. A vehicle door displacement system comprising a displacement mechanism and an arm structure, wherein the arm structure is configured to be arranged between a vehicle body structure and a vehicle door,
wherein the arm structure is configured to be pivotably connected to the vehicle body structure at an inner arm end and pivotably connected to the vehicle door at an outer arm end, and configured for displacing the vehicle door between a closed door position and an open door position,
wherein the displacement mechanism comprises a first bar and a second bar pivotably connected to each other via a bar pivot point, wherein the first bar is pivotably connected to the arm structure and the second bar is configured to be pivotably connected to the vehicle body structure,
wherein the displacement mechanism further comprises a spring extending between the inner arm end and the first bar, wherein the spring is configured for exerting an opening force onto the arm structure when the vehicle door is displaced from the closed door position to the open door position and a closing force onto the arm structure when the vehicle door is displaced from the open door position to the closed door position,
wherein during displacement from the closed door position to the open door position, the first bar and the second bar are pivoted relative to each other around the bar pivot point in a first bending direction,
wherein during displacement from the open door position to the closed door position, the first bar and the second bar are pivoted relative to each other around the bar pivot point in a second bending direction opposite the first bending direction.

2. The vehicle door displacement system according to claim 1, wherein during an initial opening displacement from the closed door position to the open door position, a first inner side of the first bar and a second inner side of the second bar are pivoted towards each other around the bar pivot point in the first bending direction, and during a final opening displacement the first inner side and the second inner side are pivoted away from each other around the bar pivot point in the first bending direction.

3. The vehicle door displacement system according to claim 1, wherein during an initial closing displacement from the open door position to the closed door position, a first outer side of the first bar and a second outer side of the second bar are pivoted towards each other around the bar pivot point in the second bending direction, and during a final closing displacement the first outer side and the second outer side are pivoted away from each other around the bar pivot point in the second bending direction.

4. The vehicle door displacement system according to claim 1, wherein the arm structure is pivotably connected to the vehicle body structure at the inner arm end via an inner arm pivot point.

5. The vehicle door displacement system according to claim 1, wherein a first outer end of the first bar is pivotably connected to the inner arm end of the arm structure via an outer bar pivot point, wherein a first inner end of the first bar is pivotably connected to the second bar via the bar pivot point,
wherein a second outer end of the second bar is pivotably connected to the first bar via the bar pivot point, wherein a second inner end of the second bar is pivotably connected to the vehicle body structure via an inner bar pivot point.

6. The vehicle door displacement system according to claim 5, wherein the arm structure is pivotably connected to the vehicle body structure at the inner arm end via an inner arm pivot point and wherein the inner arm end of the arm structure comprises a first extending portion, wherein the first extending portion is configured for extending in an inwards direction from the inner arm end towards an inner side of the vehicle when the vehicle door is arranged in the closed door position, wherein the outer bar pivot point is arranged on the first extending portion spaced apart from the inner arm pivot point.

7. The vehicle door displacement system according to claim 1, Wherein the inner arm end of the arm structure comprises a second extending portion, wherein the second extending portion is configured for extending in an outwards direction from the inner arm end towards an outer side of the vehicle when the vehicle door is arranged in the closed door position, wherein the spring is attached to the second extending portion.

8. The vehicle door displacement system according to claim 6, wherein the first extending portion and the second extending portion are arranged on a common bracket structure attached to and forming part of the arm structure.

9. The vehicle door displacement system according to claim 1, wherein the arm structure is configured to pivot relative to the vehicle body structure and the vehicle door when displacing the vehicle door between the closed door position and the open door position,
wherein upon pivoting movement of the arm structure relative to the vehicle body structure, the first bar is configured for pivoting relative to the arm structure and the second bar, and the second bar is configured for pivoting relative to the vehicle body structure and the first bar.

10. The vehicle door displacement system according to claim 1, wherein the spring is arranged as a coil spring configured for exerting an opening force onto the arm structure when the vehicle door is displaced from the closed door position to the open door position and a closing force onto the arm structure when the vehicle door is displaced from the open door position to the closed door position.

11. A vehicle comprising a vehicle door displacement system according to claim 1.

12. A method for operating a vehicle door displacement system comprising a displacement mechanism and an arm structure, wherein the arm structure is arranged between a vehicle body structure and a vehicle door,
wherein the arm structure is pivotably connected to the vehicle body structure at an inner arm end and pivotably connected to the vehicle door at an outer arm end, and configured for displacing the vehicle door between a closed door position and an open door position,
wherein the displacement mechanism comprises a first bar and a second bar pivotably connected to each other via a bar pivot point, wherein the first bar is pivotably connected to the arm structure and the second bar is pivotably connected to the vehicle body structure,
wherein the displacement mechanism further comprises a spring extending between the inner arm end and the first bar, wherein the method comprises the steps:
pivoting the first bar and the second bar relative to each other around the bar pivot point in a first bending direction during displacement of the vehicle door from the closed door position to the open door position, and exerting an opening force onto the arm structure by the spring when the vehicle door is displaced from the closed door position to the open door position;
pivoting the first bar and the second bar relative to each other around the bar pivot point in a second bending direction opposite the first bending direction during displacement of the vehicle door from the open door position to the closed door position, and exerting a closing force onto the arm structure by the spring when the vehicle door is displaced from the open door position to the closed door position.

13. The method according to claim 12, wherein the method further comprises the steps:
pivoting a first inner side of the first bar and a second inner side of the second bar towards each other around the bar pivot point in the first bending direction during an initial opening displacement from the closed door position to the open door position; and pivoting the first inner side and the second inner side away from each other around the bar pivot point in the first bending direction during a final opening displacement.

14. The method according to claims 12, wherein the method further comprises the steps:
pivoting a first outer side of the first bar and a second outer side of the second bar towards each other around the bar pivot point in the second bending direction during an initial closing displacement from the open door position to the closed door position; and pivoting the first outer side and the second outer side away from each other around the bar pivot point in the second bending direction during a final closing displacement.

15. The method according to claim 13, wherein the spring is exerting the opening force onto the arm structure during the initial opening displacement and/or the final opening displacement, and/or
wherein the spring is exerting the closing force onto the arm structure during the initial closing displacement and/or the final closing displacement.
